(19) United States
(12) Patent Application Publication
(10) Pub. No.: US 2023/0067070 A1
(43) Pub. Date: Mar. 2, 2023

(54) MIXING VACUUM

(71) Applicant: SlurryMonster, LLC, Livonia, MI (US)

(72) Inventor: Ryan Klacking, Canton, MI (US)

(21) Appl. No.: 17/896,034

(22) Filed: Aug. 25, 2022

Related U.S. Application Data
(60) Provisional application No. 63/236,829, filed on Aug. 25, 2021.

(51) Int. Cl. A47L 9/00; A47L 5/36; A47L 9/24; A47L 9/14; A47L 7/00; B01F 33/40; B01F 25/10; B01F 23/50; F16K 11/08

(52) U.S. Cl. CPC A47L 9/0072; A47L 5/365; A47L 9/248; A47L 9/1409; A47L 7/0023; B01F 33/409; B01F 33/405; B01F 25/10; B01F 23/59; F16K 11/08

(57) ABSTRACT

A vacuum assembly includes a vacuum portion having a vacuum source with an inlet and an outlet and a tank portion. A three-way inlet valve fluidly connects the inlet to the vacuum source with the tank portion when in a first position and fluidly connects the inlet to the vacuum source with an inlet to a surrounding environment when in a second position. A three-way outlet valve fluidly connects the outlet of the vacuum source with an outlet to the surrounding environment when in a first position and the outlet of the vacuum source with the tank portion when in a second position.

### REFERENCE TO RELATED APPLICATIONS

This application claims the benefit of U.S. Provisional Application No. 63/236,829 filed Aug. 25, 2021, the disclosure of which are incorporated entirely by reference.

### BACKGROUND

The present disclosure relates to a vacuum for collecting debris, such as slurry, in a tank. The debris includes solid particles, such as cement dust or dirt, that are suspended in a liquid, such as water.

### SUMMARY

In one exemplary embodiment, a vacuum assembly includes a vacuum portion having a vacuum source with an inlet and an outlet and a tank portion. A three-way inlet valve fluidly connects the inlet to the vacuum source with the tank portion when in a first position and fluidly connects the inlet to the vacuum source with an inlet to a surrounding environment when in a second position. A three-way outlet valve fluidly connects the outlet of the vacuum source with an outlet to the surrounding environment when in a first position and the outlet of the vacuum source with the tank portion when in a second position.

In another exemplary embodiment, a method of operating a vacuum assembly includes generating a negative pressure within a tank portion of the vacuum assembly with a vacuum source when a three-way inlet valve is in a first portion and a three-way outlet valve is in a first portion. Debris within the tank portion is mixed with positive pressure from the vacuum source when the three-way inlet valve is in a second position and the three-way outlet valve is in a second position.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 schematically illustrates an example vacuum assembly with an example filter assembly.

FIG. 2A schematically illustrates a cross-sectional view of the example vacuum assembly and filter assembly of FIG. 1.

FIG. 2B schematically illustrates a cross-section view of the example vacuum assembly along line 2B-2B of FIG. 1.

FIG. 3A schematically illustrates a three-way inlet valve in a suction position.

FIG. 3B schematically illustrates the three-way inlet valve in a mixing position.

FIG. 4A schematically illustrates a three-way outlet valve in a suction position.

FIG. 4B schematically illustrates the three-way outlet valve in a mixing position.

FIG. 5 schematically illustrates another example vacuum portion and an example intermediate portion for use with the vacuum assembly of FIG. 1.

FIG. 6A schematically illustrates another example three-way inlet valve in a suction position.

FIG. 6B schematically illustrates another example three-way outlet valve in a suction position.

FIG. 7A schematically illustrates the three-way inlet valve of FIG. 6A in a mixing position.

FIG. 7B schematically illustrates the three-way outlet valve in FIG. 6B in a mixing position.

FIG. 8 illustrates an example method of operating the vacuum assembly.

### DETAILED DESCRIPTION

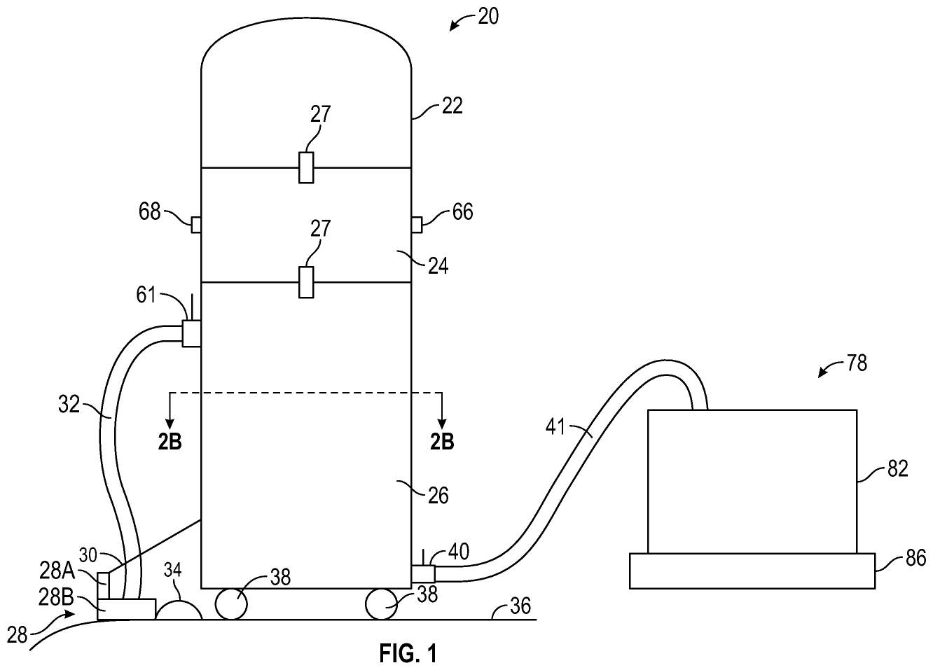

FIG. 1 schematically illustrates an example vacuum assembly 20. The vacuum assembly 20 includes a vacuum portion 22, an intermediate portion 24, and a tank portion 26 that are stacked and held together by latches 27 connecting the adjacent portions. The vacuum assembly 20 is moveable on a floor surface 36 with wheels 38 rotatably attached to the tank portion 26 to maneuver the vacuum assembly 20 to collect debris 34 on the floor surface 36 with a debris collector 28, such as a squeegee. In the illustrated example, the debris 34 can be a slurry having cementitious or dirt particle suspended in a liquid. While the vacuum portion 22, the intermediate portion 24, and the tank portion 26 are illustrated in a vertically stacked configuration, these portions could be arranged horizontally with the intermediate portion 24 and the vacuum portion 22 positioned laterally from the tank portion 26.

During operation of the vacuum assembly 20, the debris collector 28 is positioned relative to the floor surface 36 with a mechanical linkage 30 to pivot the debris collector 28 into and out of contact with the floor surface 36. The debris collector 28 includes a rigid portion 28A attached to the mechanical linkage 30 and a flexible or rubber portion 28B attached to the rigid portion 28A that engages the floor surface 36 and deforms to follow a contour of the floor surface 36.

A suction line 32 fluidly connects the debris collector 28 at an inlet end with the tank portion 26 at the outlet end to draw the debris 34 from the floor surface 36 into the tank portion 26. In this disclosure, the lines can be rigid or flexible depending on the specific application. For example, the suction line 32 is flexible to allow for relative movement between the debris collector 28 and the tank portion 26.

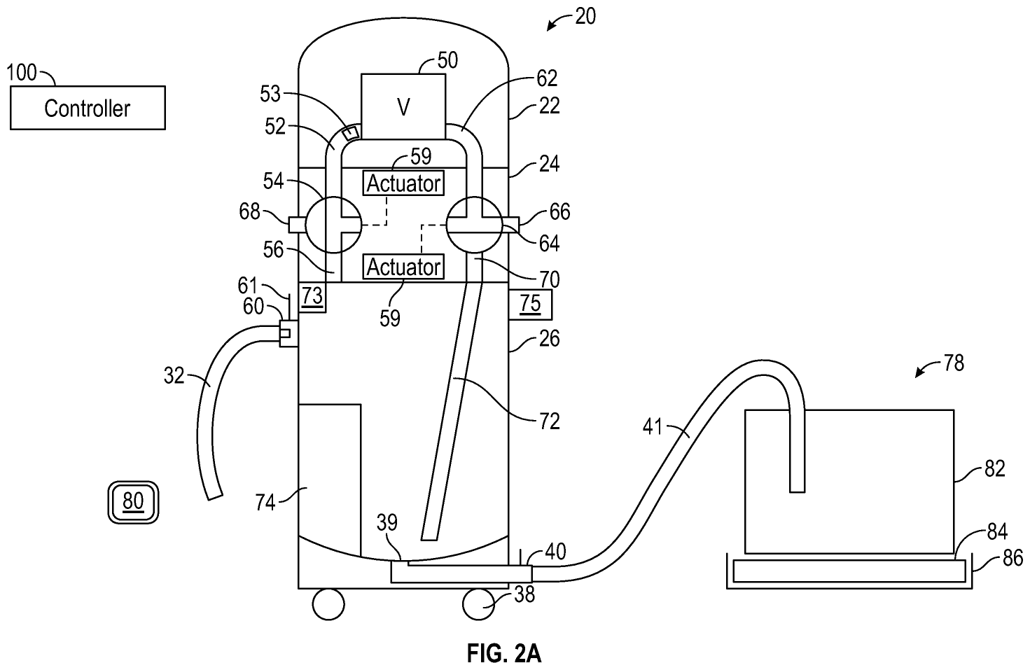

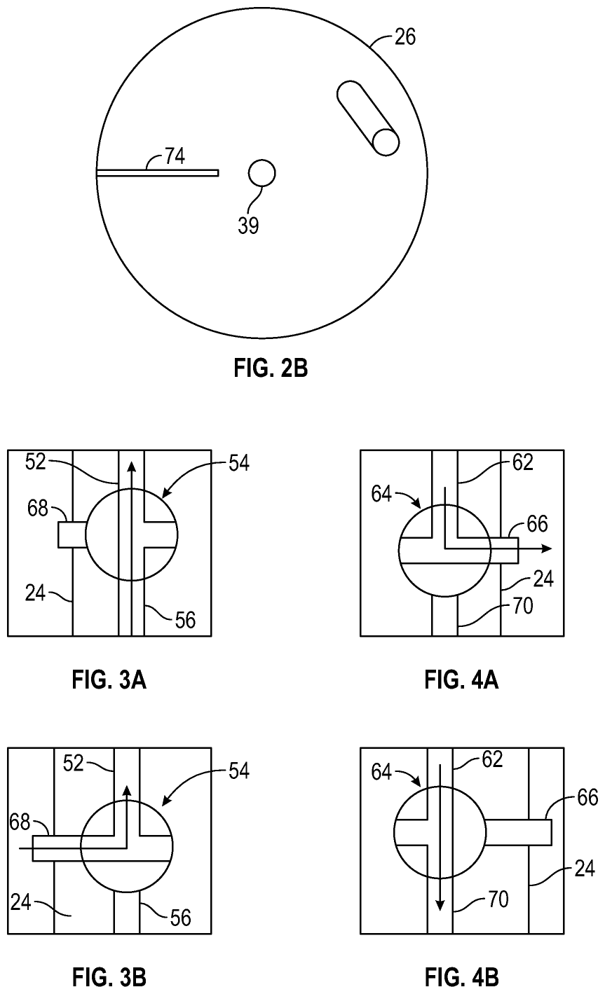

The debris 34 collected in the tank portion 26 can be discharged from the tank portion 26 when desired through a discharge valve 40 adjacent a base of the tank portion 26. The discharge valve 40 allows the debris 34 to pass through an opening 39 (FIGS. 2A-2B) in the base of the rank and through the discharge line 41 to another location. In the illustrated example, the debris 34 is transferred through the discharge line 41 to a filter assembly 78 to remove the suspended particles from the liquid.

FIG. 2A schematically illustrates a cross-sectional view of the vacuum assembly 20 and the filter assembly 78. An inlet to a vacuum 50, such as a vacuum source, in the vacuum portion 22 is fluidly connected to a three-way inlet valve 54 in the intermediate portion 24 through a vacuum inlet line 52. A dry dust or HEPA filter canister 53 can be located in the vacuum inlet line 52 to collect airborne particles such as silica dust. The three-way inlet valve 54 is moveable between a first position (FIG. 3A) and a second position (FIG. 3B). In the first position, the three-way inlet valve 54 fluidly connects the vacuum 50 to the tank portion 26 through an inlet line 56. In the second position, the three-way inlet valve 54 fluidly connects the vacuum 50 with a surrounding environment through an inlet 68 that extends through a side of the intermediate portion 24. When the three-way inlet valve 54 is in the second position, the vacuum 50 no longer creates negative pressure within the tank portion 26.

A three-way outlet valve 64 controls a direction of the positive pressure generated by the vacuum 50. In particular, the three-way outlet valve 64 is fluidly connected to the vacuum 50 through a vacuum outlet line 62. The three-way outlet valve 64 is movable between a first positioned (FIG. 4A) and a second position (FIG. 4B). In the first position, the three-way outlet valve 64 fluidly connects the positive pressure generated by vacuum 50 with the surrounding environment though an outlet 66 extending through a side of the intermediate portion 24. In the second position, the three-way outlet valve 64 fluidly connects the vacuum 50 with the tank portion 26 through an outlet line 70 to create a positive pressure in the tank portion 26. The three-way inlet and outlet valves 54, 64 can be controlled by at least one actuator 59 (FIG. 2A) in electrical communication with a controller 100 or operated manually.

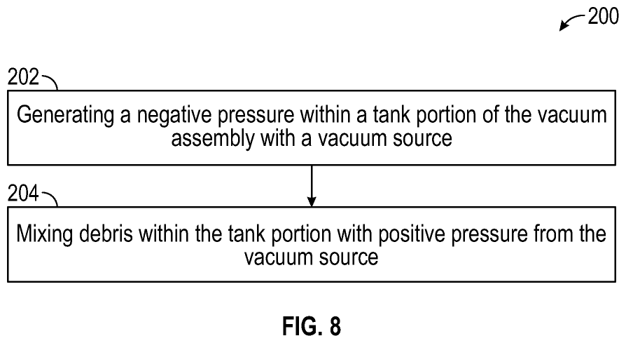

FIG. 8 illustrates an example method 200 of operating the vacuum assembly 20. In the example method 200, a negative pressure is generated within the tank portion 26 (See Block 202) by the vacuum 50. When the vacuum 50 is generating negative pressure in the tank portion 26, the three-way inlet valve 54 is positioned to fluidly connect the vacuum inlet line 52 with the inlet line 56 to the tank portion 26 (FIG. 3A). The three-way outlet valve 64 is then positioned to fluidly connect the vacuum 50 with the surrounding environment through the outlet 66 (FIG. 4A). When there is negative pressure in the tank portion 26, the suction line 32 can then evacuate the debris 34 from the floor surface 36 or any other surface into the tank portion 26.

A float switch 73 (FIG. 2A) is located in the tank portion 26 to prevent over filling the tank portion 26 and is in electrical communication with the controller 100. In the illustrated example, the controller includes a processor and memory programmed to perform the operations described herein. The controller 100 can be located internally or externally to the vacuum assembly 20 to allow interaction with a user of the vacuum assembly 20.

In the illustrated example, the suction line 32 is connected to the tank portion 26 through a quick fit connection 60 having a male portion that fits within a female portion. The quick fit connection 60 can be integral with or separate from a valve 61 that allows the debris 34 to enter the tank portion 26 when in an open position and isolates the tank portion 26 from the surrounding environment when in a closed position.

When the tank portion 26 is full of the debris 34 such that no more debris 34 can be evacuated through the suction line 32, the debris 34 in the tank portion 26 can be mixed (See FIG. 8 and Block 204) with a flocculant 80 (FIG. 2A). When mixing the debris 34 in the tank portion 26, the three-way inlet valve 54 is moved to the second position (FIG. 3B) to draw air from the inlet 68 that is in fluid communication with the surrounding environment with the vacuum 50. In this configuration, the inlet line 56 is fluidly isolated from the vacuum 50. The valve 61 is also positioned in the closed position to prevent fluid exchange from the tank portion 26 and the suction line 32. Also, the three-way outlet valve 64 is moved to the second position (FIG. 4B) to connect the outlet line 62 with the tank portion 26 through the outlet line 70. A pressure relief valve 75 prevents the tank portion 26 from over pressurizing.

In this configuration, the outlet line 70 is fluidly connected with a fluid mixing tube 72 that extends from a top region of the tank portion 26 to a bottom region of the tank portion 26. One feature of the fluid mixing tube 72 is to mix the debris 34, which is in liquid form, in the tank portion 26. The fluid mixing tube 72 utilizes the positive pressure from the vacuum 50 to create a jet of air that can form a vortex of the fluid in the tank portion 26.

In the illustrated example, the fluid mixing tube 72 is positioned such that it extends in a direction with a circumferential component relative to a cylindrical sidewall of the tank portion 26 to create the fluid vortex (See FIGS. 2A and 2B). The fluid mixing tube 72 can be made of a rigid material, such as a metal or a polymer. In another example, the fluid mixing tube 72 can be made of a flexible material to allow movement of the fluid mixing tube 72 within the tank portion 26 in a random motion. Also, when using either the rigid or flexible mixing tubes 72, the flocculant 80 and the debris 34 within the tank portion 26 can be mixed by air bubbles rising through the debris 34 in addition to the fluid vortex or in place of the fluid vortex.

When the tank portion 26 forms a vortex, a turbulence generating projection 74, such as a fin, projects perpendicular from an inner surface of the cylindrical sidewall of the tank portion 26. The turbulence in the vortex created from the projection 74 improves mixing of the debris 34 and the flocculant 80 inside the tank portion 26. In the illustrated example, the projection 74 extends at least 50% of a vertical height of the tank portion 26 when the vacuum assembly 20 is in a normal operating position on the floor surface 36. In one example, the projection 74 extends less than 50% of the vertical height of the tank portion 26. In another example, the projection 74 also extends less than 50% and more than 10% of a diameter of the tank portion 26. In yet another example, the projection extends less than 50% and more than 25% of a diameter of the tank portion 26.

One feature of mixing the flocculant 80 with the debris 34 in the tank portion 26 is the formation of larger particles of debris 34 suspended in the liquid. The larger particle size improves the ability of a filter 82 in the filter assembly 78 to collect the particles from the debris 34 that would otherwise pass through or clog the filter 82. In particular, as shown in FIGS. 1 and 2, the filter assembly 78 can include the filter 82 located on a pallet 84 in a catch basin 86 for collecting the liquid from the debris 34 when the particles have been captured by the filter 82.

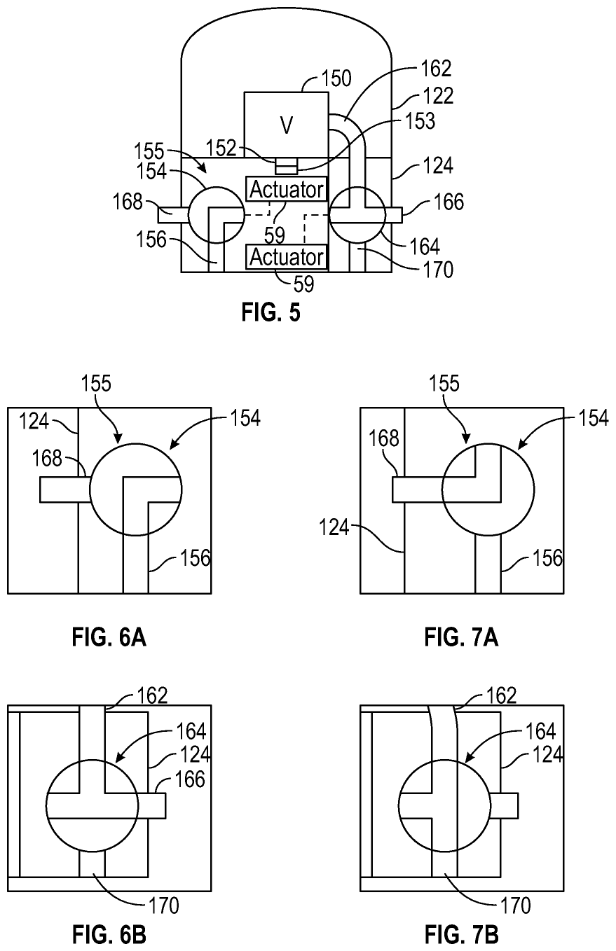

FIG. 5 illustrates another example vacuum portion 122 and intermediate portion 124. The vacuum portion 122 and the intermediate portion 124 are similar to the vacuum portion 22 and the intermediate portion 24 except where described below or shown in the Figures. Similar numbers are used between the vacuum portion 122 and intermediate portion 124 as compared to the vacuum portion 22 and the intermediate portion 24, respectively, with the addition of a leading 1 to identify similar or identical components.

A vacuum 150 is located in the vacuum portion 122 and includes an inlet portion 152 in fluid communication with a pressurized chamber 155. A dry dust or HEPA filter canister 153 can be located in the inlet portion 152 to collect airborne particles such as silica dust. The pressurized chamber 155 is located within the intermediate portion 124 and includes a three-way inlet valve 154. When the vacuum portion 122 and the intermediate portion 124 are used to generate negative pressure within the tank portion 26, the three-way inlet valve 154 will connect the pressurized chamber 155 with the inlet line 156 to the tank portion 26 as shown in FIG. 6A. A three-way outlet valve 164 is also located in the intermediate portion 124 and fluidly connects an outlet line 162 with an outlet 166 to direct the positive pressure from the vacuum 150 to the surrounding environment as shown in FIG. 6B.

When the vacuum portion 122 and the intermediate portion 124 are used to mix the tank portion 26, the three-way inlet valve 154 fluidly connects the surrounding environment at an inlet 168 with the pressurized chamber 155 (FIG. 7A). Also, the three-way outlet valve 164 connects the outlet line 162 with an outlet line 170 (FIG. 7B) during mixing. The outlet line 170 connects to the fluid mixing tube 72 within the tank portion 26 (FIG. 2A) for mixing as described above.

Although the different non-limiting examples are illustrated as having specific components, the examples of this disclosure are not limited to those particular combinations. It is possible to use some of the components or features from any of the non-limiting examples in combination with features or components from any of the other non-limiting examples.

It should be understood that like reference numerals identify corresponding or similar elements throughout the several drawings. It should also be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claim should be studied to determine the true scope and content of this disclosure.

What is claimed is:

1. A vacuum assembly comprising:
a vacuum portion including a vacuum source having an inlet and an outlet;
a tank portion;
a three-way inlet valve fluidly connecting the inlet to the vacuum source with the tank portion when in a first position and fluidly connecting the inlet to the vacuum source with an inlet to a surrounding environment when in a second position; and
a three-way outlet valve fluidly connecting the outlet of the vacuum source with an outlet to the surrounding environment when in a first position and the outlet of the vacuum source with the tank portion when in a second position.

2. The assembly of claim 1, wherein the three-way inlet valve and the three-way outlet valve are located in an intermediate portion.

3. The assembly of claim 2, wherein intermediate portion defines a pressurizable chamber upstream of the inlet to the vacuum source.

4. The assembly of claim 2, wherein the intermediate portion is attached to the tank portion on a first end and the vacuum portion on a second end.

5. The assembly of claim 4, wherein the intermediate portion is removably attached to the vacuum portion on a first end and the tank portion on a second end.

6. The assembly of claim 1, wherein the tank portion is supported on wheels.

7. The assembly of claim 1, including a suction line fluidly connecting a debris collector and the tank portion.

8. The assembly of claim 1, including a mixing tube fluidly downstream of vacuum source when the three-way outlet valve is in the second position and the mixing tube extends into the tank portion.

9. The assembly of claim 8, wherein the mixing tube includes an outlet at a distal end.

10. The assembly of claim 8, wherein the tank portion is cylindrical and the mixing tube extends in a direction having a circumferential component relative to a circumference of the tank portion.

11. The assembly of claim 10, wherein the mixing tube includes an outlet at a distal end.

12. The assembly of claim 10, include a turbulence generating projection extending from an inner wall of the tank portion.

13. The assembly of claim 12, wherein the turbulence generating projection extends at least 50% of a height of the tank portion.

14. The assembly of claim 12, wherein the turbulence generating projection extends less than 50% and more than 10% of a diameter of the tank portion.

15. A method of operating a vacuum assembly, the method comprising:
generating a negative pressure within a tank portion of the vacuum assembly with a vacuum source when a three-way inlet valve is in a first portion and a three-way outlet valve is in a first portion; and
mixing debris within the tank portion with positive pressure from the vacuum source when the three-way inlet valve is in a second position and the three-way outlet valve is in a second position.

16. The method of claim 15, wherein an inlet to the vacuum source is in fluid communication with the tank portion when in the first position and a surrounding environment when in the second position.

17. The method of claim 16, wherein an outlet to the vacuum source is in fluid communication with the surrounding environment when in first position and the tank portion when in the second position.

18. The method of claim 17, wherein the positive pressure passes through a mixing tube when the three-way outlet valve is in the second position.

19. The method of claim 18, wherein the positive pressure passing through the mixing tube generates a vortex within the tank portion.

20. The method of claim 19, wherein a turbulence generating projection extends from an interior wall of the tank portion.
